(19) United States
(12) Patent Application Publication
(10) Pub. No.: US 2011/0243782 A1
(43) Pub. Date: Oct. 6, 2011

(54) Soft Serve Ice Cream Pump Enhancers

(76) Inventor: Richard Allen Drazkowski, Winona, MN (US)

(21) Appl. No.: 13/041,413

(22) Filed: Mar. 6, 2011

Related U.S. Application Data
(60) Provisional application No. 61/341,305, filed on Mar. 30, 2010.

(51) Int. Cl. F04C 29/00; A23G 9/04

(52) U.S. Cl. 418/206.9; 418/206.1

(57) ABSTRACT

The present invention relates to a pump enhancer that allows the pump in the soft ice cream machine to operate at maximum capacity. The preferred pump enhancer is made of NSF approved Virgin Teflon film and is used in a two-gear pump soft ice cream machines to take up the space of the pump cover that wears out annually, and thus increasing the efficiency of the soft serve ice cream machines and produce more product (ice cream) per box of ice cream mix. The spacer also allows the pump to put maximum air into the product and is cost saving. The pump enhancer can be installed during rebuilding of pump or during the initial manufacture thereof.

### REFERENCE TO RELATED APPLICATIONS

This patent application claims the benefit of U.S. Provisional Application No. 61/341305 filed on Mar. 30, 2010, the disclosure of which is incorporated herein by reference in its entirety.

### BACKGROUND OF THE INVENTION

1. Field of the Invention

The present invention relates to pump enhancers that allow the pump in the soft serve ice cream machines to operate at maximum capacity, and more particularly to PTFE spacers that can enhance gear pump soft serve ice cream machines' efficiency by increasing the volume of finished product per box of ice cream mix.

2. Description of Related Art

In the mechanical production of ice cream and other frozen dessert products, an ice cream mix is normally combined with a non-toxic gas such as air in order to produce a tasteful, palatable and profitable end product. For soft serve ice cream, the air content can vary from 0% to 60% of the total volume of the finished product. The amount of air alters the taste of the finished product. Product with low quantities of air has a heavy, icy taste while product with higher air content tastes creamier, smoother and lighter. The optimum quantity of air is determined by the other ingredients and individual taste. In general, the preferred air content is between 30% and 45% of volume.

The soft serve ice cream liquid mix is kept preserved at the ideal temperature in a tank (stainless steel or other material) that is refrigerated and controlled by a thermostat. The ice cream mix remains there until it is delivered by means of gravity or a gear pump into the freezing chamber where it is intimately mixed with the targeted quantity of air, stirred, and quickly frozen to obtain a soft serve ice cream.

An important reason for a machine to have a gear pump is to increase the volume of the ice cream by adding air to the ice cream mix. This affects the machine in two ways: First, it reduces the amount of mix in a given volume of ice cream, which increases the number of liters the machine is able to freeze per hour; and, secondly, it decreases the density of ice cream, and thus increases ice cream “softness” creating a sensation that it is less cold to the palate.

Under ideal working condition, the pump delivers a constant, perfect supply of liquid mix and gas (usually air) to the freezing chamber in a predetermined ratio between air and liquid mix. However, the pump may not work under expected ideal condition due to imperfect mechanical assembly or the pump may wear out gradually; the ratio between air and ice cream mix may be decreased, the volume of ice cream produced per box of ice cream mix may be decreased; the taste of ice cream may be changed; the production performance of the machine may be compromised. Therefore there is a need to provide solutions to overcome the aforementioned problems to improve the efficiency of the soft serve ice cream machines.

### SUMMARY OF THE INVENTION

The primary object of the present invention is to provide a device that overcomes the problems such as high density and low volume of ice cream caused by the pump cover that wears out gradually.

The object of the present invention is to provide a device that enhances the amount of air that gets pumped into ice cream by a soft serving ice cream machine.

The object of the present invention is to provide a device that produces less density and high volume of ice cream and is cost saving.

The object of the present invention is to provide a device that allows the pump in the soft serve ice cream machine to operate at maximum capacity.

As indicated in the expired U.S. Pat. Nos. 3,628,893 and 3,764,238, the two gear pumps in the ice cream machine delivers and mixes ice cream liquid mix and air for the formation of liquid and air emulsions by which the volume of air in the finished product (ice cream) may be adjusted according to the predetermined ratio of air (gaseous phase) and the ice cream mix (liquid phase). The present invention is compatible with several soft serve ice cream machines in the market including but not limited to some models from Caprigiani, Coloelite, Promag, Dairy Den, Cattabriga that utilize two gear pumps to deliver and mix air with the ice cream liquid mix for formation of ice cream mixture (emulsion).

The gear pump usually includes a pump body, a pump cover tightly fastened to the pump body by means of suitable bolts. Inside the pump body, a pair of gears in mesh with one another is housed. A suitable O-ring housed inside a groove around the circumference of the pump body assures a fluid tight seal between pump body and pump cover. For most of gear pumps, if the mechanic assembly is not perfect, there may be a tiny gap between the gears and the pump cover or the pump cover may wear out gradually causing a small gap between the gear and the pump cover. If the gap occurs, it may adversely affect the ratio of air-to-ice cream mix and thus affect the taste of ice cream and produce high density and less quantity of finished product (ice cream) per box of ice cream mix.

The function of the pump enhancer according to the present invention is to fill the gap between gears and the pump cover, especially to take up the space of the pump cover that wears out annually. The pump enhancer (also called “spacer” in the present application) can be made of NSF approved Virgin Teflon film. It can be made of other materials suitable for the intended purpose. The pump enhancer can be in different shapes including but not limited to two connected rings, two separate rings, etc. In the preferred embodiment, the pump enhancer is in the shape of an “8” formed by two connected rings. The outer radii of the two rings are same and are approximately as same as that of the two gears in the pump, while the inner radii of the two rings are different. One ring's inner radius is approximately the same as that of one gear; the other ring's inner radius is approximately the same as that of the other gear. Both radii for both rings may be different so as to match with different gears used in different machines. The thickness of the spacer is about 0.010-0.025 inches. The preferred embodiment of the spacer comes in 3 thicknesses: 0.010, 0.015, and 0.020 inches. A 0.010 inch thick spacer may be used to fill the gap between gears and the pump cover in the beginning to maximize the capacity of the pump or to protect the pump cover from friction/wearing thus extend the life time of the pump cover. When the pump fails in 1-2 years, the 0.015 inch spacer can be used to fill the gap due to wearing of pump cover. When the pump fails again in another 1-2 years, the 0.020 inch spacer can be used to fill the gap due to continuous wearing of pump cover. The pump enhancer of the present invention allows the pump in soft serve ice cream machine to operate at maximum capacity and extends the life time of pump up to 4-8 years. The pump enhancer also allows the pump to put maximum air into the product, which increases profits. The pump enhancer can be installed during rebuilding of pump or during the initial manufacture thereof.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is an exploded perspective view of a gear pump wherein an embodiment of the pump enhancer (spacer) of the present invention is installed.

FIG. 2 is a top view of an embodiment of the pump enhancer (spacer) according to the present invention with dimensions matched with the gears.

### DESCRIPTION OF THE PREFERRED EMBODIMENT

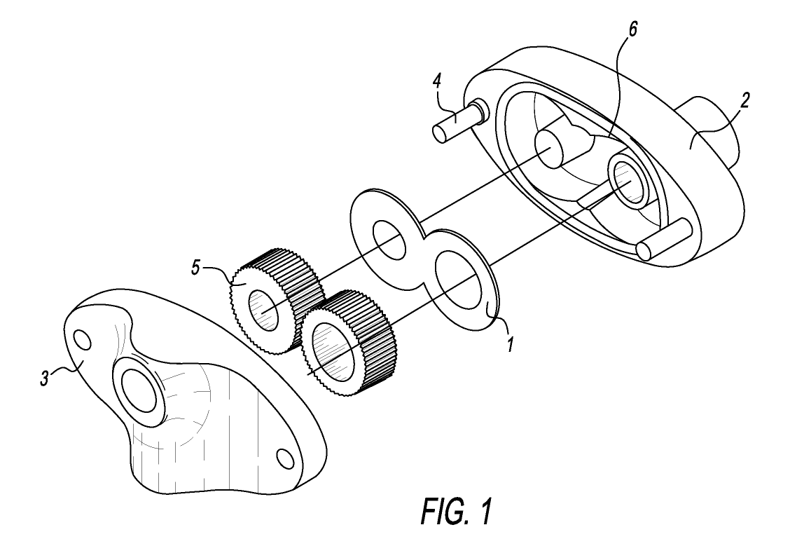

FIG. 1 is an exploded perspective view of a gear pump wherein an embodiment of the pump enhancer (also called “spacer” in the present application) 1 of the present invention is installed. The gear pump shown in FIG. 1 includes a pump body 2, a pump cover 3 fastened to the pump body 2 by means of suitable bolts 4. Inside the pump body 2 a pair of gears 51 and 52 in mesh with one another is housed. A suitable O-ring 6 housed inside a groove around the circumference of the pump body 2 assures a fluid tight seal between pump body 2 and cover 3. The pump enhancer (spacer) 1 is installed in the pump body; then the gears 51 and 52 are installed, followed by the pump cover 3. Lubricate all parts. The function of the spacer 1 of the present invention is to protect the pump cover 3 from friction/wearing or to fill the gap between the gears 5 and the pump cover 3, especially, to take up the space of the pump cover 3 that wears out annually.

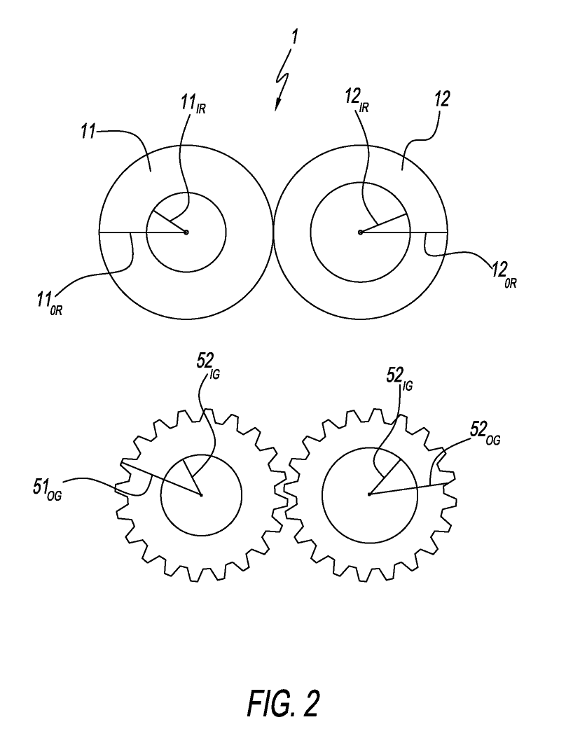

Referring to FIG. 2, there is disclosed a top view of an embodiment of the spacer 1 according to the present invention. The spacer 1 may be made of NSF approved Virgin Teflon film. It may be made of other materials known in the art for intended purpose. The spacer 1 may have different shapes. In the preferred embodiment, the spacer 1 has the shape of an “8” formed by two connected rings 11 and 12. The outer radii of the two rings 11_{OR} and 12_{OR} are the same and are approximately as same as that of the two gears 51_{OG} and 52_{OG} in the pump, while the inner radii of the two rings 11_{IR} and 12_{IR} are different. The inner radius of ring 11_{IR} is approximately the same as that of gear 51_{IG}; the inner radius of ring 12_{IR} is approximately the same as that of gear 52_{IG}. The thickness of the PTFE spacer 1 of the present invention is about 0.010-0.025 inches. In the preferred embodiment, the PTFE spacer 1 comes in 3 thicknesses; 0.010., 0.015, and 0.020 inches. A 0.010 inch thick PTFE spacer 1 may be used to prevent the pump cover 2 from friction/wearing or fill the gap between gears 5 and the pump cover 3 in the beginning to maximize the capacity of the pump. When the pump fails in 1-2 years, the 0.015 inch PTFE spacer 1 can be used to fill the gap due to wearing of the pump cover 3. When the pump fails again in another 1-2 years, the 0.020 inch PTFE spacer 1 can be used to fill the gap due to continuous wearing of the pump cover 3. The pump enhancer 1 of the present invention allows the pump in the soft serve ice cream machine to operate at maximum capacity and extends the life time of the pump up to 4-8 years. The pump enhancer 1 also allows the pump to put maximum air into the product, which increases profits. The pump enhancer 1 can be installed during rebuilding of pump or during the initial manufacture thereof.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A pump enhancer for allowing the pump in the soft serve ice cream machines to operate at maximum capacity; said pump enhancer is installed in a pump body, followed by a pair of gears in mesh with one another, and followed by a pump cover.

2. The pump enhancer of claim 1 is made of NSF approved Virgin Teflon film.

3. The pump enhancer of claim 1 may be made of other materials known in the art for intended purpose.

4. The pump enhancer of claim 1, wherein said pump enhancer having two connected rings in the shape of an “8”; said two connected rings having approximately the same outer radius as that of said gears; said two connected rings having different inner radii, one of said rings' inner radius is approximately the same as that of one said gear, the other ring's inner radius is approximately the same as that of the other said gear.

5. The pump enhancer of claim 1, wherein said pump enhancer may be in different shapes and different dimensions.

6. The pump enhancer of claim 1, wherein the thickness of said pump enhancer may be about 0.010-0.025 inches.

7. The pump enhancer of claim 1 is used to enhance the amount of air that gets pumped into the ice cream by a soft serving ice cream machine; said pump enhancer helps to produce less-density and high volume of ice cream and is cost saving.

8. A pump enhancer for allowing the pump in the soft serve ice cream machines to operate at maximum capacity; said pump enhancer is installed in a pump body, followed by a pair of gears in mesh with one another, and followed by a pump cover; said pump enhancer having two connected rings in the shape of an “8”; said two connected rings having approximately the same outer radius as that of said gears; said two connected rings having different inner radii, one of said rings' inner radius is approximately the same as that of one said gear, the other ring's inner radius is approximately the same as that of the other said gear.

9. The pump enhancer of claim 8 is made of NSF approved Virgin Teflon film.

10. The pump enhancer of claim 8, wherein the thickness of said pump enhancer may be about 0.010-0.025 inches.

11. The pump enhancer of claim 8 is used to enhance the amount of air that gets pumped into the ice cream by a soft serving ice cream machine; said pump enhancer helps to produce less-density and high volume of ice cream and is cost saving.

12. The pump enhancer of claim 1 can be installed during rebuilding of pump or during the initial manufacture thereof.

13. The pump enhancer of claim 8 can be installed during rebuilding of pump or during the initial manufacture thereof.

14. A gear pump utilizing pump enhancer to maximize production of soft serve ice cream comprises a pump enhancer of the present invention; said pump enhancer is installed in a pump body, followed by a pair of gears in mesh with one another, and followed by a pump cover.
